(19) United States
(12) Patent Application Publication
(10) Pub. No.: US 2025/0085415 A1
(43) Pub. Date: Mar. 13, 2025

(54) SYSTEM AND METHOD FOR DETECTING PLUGGING OF AN AGRICULTURAL IMPLEMENT

(71) Applicant: CNH Industrial America LLC, New Holland, PA (US)

(72) Inventors: Scott Glovier, McMurray, PA (US); Raul Espinosa, Cranberry Township, PA (US); Heather Humphreys Paxinos, Lemont, IL (US)

(21) Appl. No.: 18/463,503

(22) Filed: Sep. 8, 2023

(51) Int. Cl. G01S 13/88; A01B 63/00; A01B 79/00

(52) U.S. Cl. CPC G01S 13/88; A01B 63/008; A01B 79/00

(57) ABSTRACT

A system for detecting plugging of an agricultural implement includes a ground-engaging tool configured to be moved through soil and a radar sensor configured to generate data indicative of the flow of the soil in the portion of the field through which the tool is moving. The system also includes a computing system configured to receive the radar sensor data indicative of the flow of the soil and generate a representation of the flow of the soil based on the received radar sensor data. Additionally, the computing system is configured to remove one or more components of the agricultural implement from the generated representation such that a modified representation of the flow of the soil in the portion of the field through which the ground-engaging tool is moving is created. Furthermore, the computing system is configured to determine when the tool is plugged based on the generated modified representation.

### FIELD OF THE INVENTION

The present disclosure generally relates to agricultural implements and, more particularly, to systems and methods for detecting plugging of an agricultural implement.

### BACKGROUND OF THE INVENTION

It is well known that, to attain the best agricultural performance from a field, a farmer must cultivate the soil, typically through a tillage operation. Modern farmers perform tillage operations by pulling a tillage implement behind an agricultural vehicle, such as a tractor. Tillage implements typically include one or more ground-engaging tools, such as shanks, harrow disc blades, leveling blades, and/or the like, that are configured to loosen and/or otherwise agitate the soil to prepare the field for subsequent planting operations.

During tillage operations, field materials, such as residue, soil, rocks, and/or the like, may become trapped or otherwise accumulate on one or more of the ground-engaging tools and/or between adjacent pairs of ground-engaging tools. When such accumulations of field materials become sufficient to prevent the ground-engaging tools from providing adequate tillage to the field (e.g., by preventing shanks from penetrating the soil at a desired depth), then the ground-engaging tools are plugged. In such instances, it is necessary for the operator to take certain corrective actions to remove the accumulated field materials. However, it may be difficult for the tillage implement operator to determine when the ground-engaging tools are plugged (e.g., due to dust). In this respect, systems have been developed to detect plugging of the agricultural implement during tillage operations. While such systems work well, further improvements are needed.

Accordingly, an improved system and method for detecting plugging of an agricultural implement that overcomes one or more of the issues in the prior art would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for detecting plugging of an agricultural implement. The system includes a ground-engaging tool configured to be moved through soil of a field as the agricultural implement travels across the field. Furthermore, the system includes a radar sensor configured to generate data indicative of a flow of the soil in the portion of the field through which the ground-engaging tool is moving. Additionally, the system includes a computing system communicatively coupled to the radar sensor. The computing system is configured to receive the data from the radar sensor indicative of the flow of the soil in the portion of the field through which the ground-engaging tool is moving. Moreover, the computing system is configured to generate a representation of the flow of the soil in the portion of the field through which the ground-engaging tool is moving based on the received data from the radar sensor. Furthermore, the computing system is configured to remove one or more components of the agricultural implement from the generated representation such that a modified representation of the flow of the soil in the portion of the field through which the ground-engaging tool is moving is created. Additionally, the computing system is configured to determine when the ground-engaging tool is plugged based on the modified representation.

In another aspect, the present subject matter is directed to a method for detecting plugging of an agricultural implement. The method includes receiving, with a computing system, radar sensor data from a radar sensor configured to generate data indicative of a flow of the soil in a portion of the field through which the ground-engaging tool is moving. Additionally, the method includes generating, with the computing system, a representation of the flow of the soil in the portion of the field through which the ground-engaging tool is moving based on the received data from the radar sensor. Moreover, the method includes removing, with the computing system, one or more components of the agricultural implement from the generated representation such that a modified representation of the flow of the soil in the portion of the field through which the ground-engaging tool is moving is created. Furthermore, the method includes determining, with the computing system, when the ground-engaging tool is plugged based on the modified representation. Additionally, the method includes initiating, with the computing system, a control action when determined that the ground-engaging tool is plugged.

In a further aspect, the present subject matter is directed to an agricultural implement. The agricultural implement includes a frame and a wheel supporting the frame and configured to allow movement of the agricultural implement across a field. The agricultural implement also includes a ground-engaging tool supported by the frame and configured to be moved through soil of the field as the agricultural implement travels across the field. Additionally, the agricultural vehicle includes a radar sensor configured to generate data indicative of a flow of the soil in a portion of the field through which the ground-engaging tool is moving. Moreover, the agricultural vehicle includes a computing system communicatively coupled to the radar sensor. The computing system is configured to receive the data from the radar sensor indicative of the flow of the soil in the portion of the field through which the ground-engaging tool is moving. Moreover, the computing system is configured to generate a representation of the flow of the soil in the portion of the field through which the ground-engaging tool is moving based on the received data from the radar sensor. Furthermore, the computing system is configured to remove at least one of the ground-engaging tool or the wheel of the agricultural implement from the generated representation such that a modified representation of the flow of the soil in the portion of the field through which the ground-engaging tool is moving is created. Additionally, the computing system is configured to determine when the ground-engaging tool is plugged based on the modified representation.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural implement coupled to an agricultural vehicle in accordance with aspects of the present subject matter;

FIG. 2 illustrates a side view of one embodiment of a ground-engaging tool of an agricultural implement in accordance with aspects of the present subject matter;

FIG. 3 illustrates a schematic view of one embodiment of a system for detecting plugging of an agricultural implement in accordance with aspects of the present subject matter;

FIG. 4 illustrates a flow diagram of one embodiment of control logic for detecting plugging of an agricultural implement in accordance with aspects of the present subject matter; and

FIG. 5 illustrates a flow diagram of one embodiment of a method for detecting plugging of an agricultural implement in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for detecting plugging of an agricultural implement. Specifically, the agricultural implement includes one or more ground-engaging tools configured to be moved through the soil of a field as the agricultural implement travels across the field, typically when towed by an agricultural vehicle during agricultural operations (e.g., tillage operations). As the ground-engaging tools travel across the field during agricultural operations, soil may accumulate on the ground-engaging tools. The ground-engaging tools may become plugged when enough soil and/or residue has accumulated thereon such that the performance of the tools has been degraded or otherwise impacted.

To detect plugging of the ground-engaging tools of the agricultural implement, the system includes one or more radar sensors, which may be mounted on the agricultural implement. Each radar sensor may, in turn, have a detection zone directed at a portion of the field adjacent to one of the ground-engaging tools of the agricultural implement. As such, each radar sensor may be configured to generate data indicative of a flow of the soil, such as the speed of the soil relative to the ground speed of the agricultural implement, in its corresponding detection zone.

Furthermore, a computing system of the disclosed system is configured to detect when one or more of the ground-engaging tools are plugged based on the data generated by the radar sensor(s). More specifically, the computing system may be configured to receive data from the radar sensor(s) indicative of the flow of the soil. Moreover, the computing system is configured to generate one or more representations of the flow of the soil in the portion of the field through which the ground-engaging tools are moving based on the received data from each radar sensor. For example, the generated representation(s) of the flow of the soil may include a plurality of three-dimensional images of the soil. Additionally, the computing system of the disclosed system may thereafter remove one or more components of the agricultural implement, such as the ground-engaging tool(s) and/or the wheel(s), such that modified representation of the flow of the soil in the portion of the field through which the ground-engaging tools are moving is created. Thus, the modified representation may include a representation of the flow of the soil without including the agricultural implement in the representation. Thereafter, the computing system may determine when the ground-engaging tool is plugged based on the modified representation.

Removing one or more components of the agricultural implement from the generated representation allows the computing system to focus on the soil within the modified representation at the exclusion of components of the agricultural implement. As such, the computing system may use fewer computing resources, such as memory, to determine when the agricultural implement is plugged. Additionally, the processing speed of the computing system may increase, as the computing system will not be required to process as much data to determine when the agricultural implement is plugged.

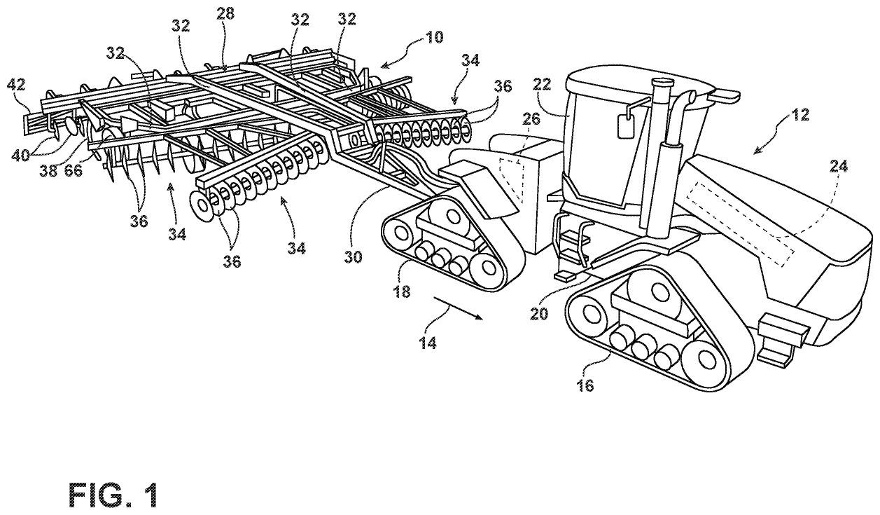

Referring now to the drawings, FIG. 1 illustrates a perspective view of the agricultural implement 10 coupled to an agricultural vehicle 12. In general, the agricultural implement 10 may be configured to be towed across a field in a direction of travel (e.g., as indicated by arrow 14 in FIG. 1) by the agricultural vehicle 12. As shown, the agricultural implement 10 may be configured as a tillage implement, and the agricultural vehicle 12 may be configured as an agricultural tractor. However, in other embodiments, the agricultural implement 10 may be configured as any other suitable type of implement, such as a seed-planting implement, a fertilizer-dispensing implement, and/or the like. Similarly, the agricultural vehicle 12 may be configured as any other suitable type of vehicle, such as an agricultural harvester, a self-propelled sprayer, and/or the like.

As shown in FIG. 1, the agricultural vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices (e.g., a user interface) for permitting an operator to control the operation of one or more components of the agricultural vehicle 12 and/or one or more components of the agricultural implement 10. Additionally, the agricultural vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

Additionally, as shown in FIG. 1, the agricultural implement 10 may generally include one or more wheels 66 configured to allow movement of the agricultural implement 10 across the field in the direction of travel 14, and a frame 28 coupled to and supported by the wheel(s) 66. The frame 28 is configured to be towed by the agricultural vehicle 12 via a pull hitch or tow bar 30 in the direction of travel 14. In general, the frame 28 may include a plurality of structural frame members 32, such as beams, bars, and/or the like, configured to support or couple to a plurality of components. As such, the frame 28 may be configured to support a plurality of ground-engaging tools, such as a plurality of shanks, disk blades, leveling blades, basket assemblies, tines, spikes, and/or the like. In one embodiment, the various ground-engaging tools may be configured to perform a tillage operation or any other suitable ground-engaging operation on the field across which the agricultural implement 10 is being towed. For example, in the illustrated embodiment, the frame 28 is configured to support various gangs 34 of disc blades 36, a plurality of ground-engaging shanks 38, a plurality of leveling blades 40, and a plurality of crumbler wheels or basket assemblies 42. However, in alternative embodiments, the frame 28 may be configured to support any other suitable ground-engaging tool(s) or combinations of ground-engaging tools.

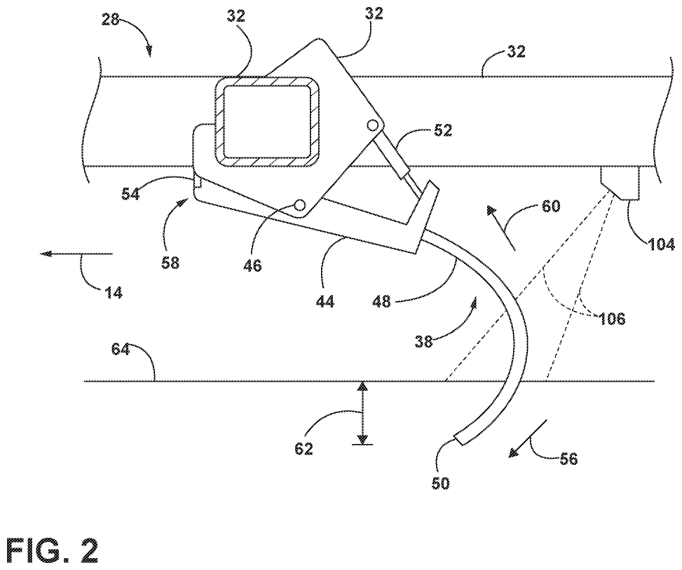

Referring now to FIG. 2, a side view of one embodiment of one of the shanks 38 is illustrated in accordance with aspects of the present subject matter. As shown, the shank 38 may generally include a base portion 44 pivotally coupled to one of the frame members 32 of the implement frame 28 (e.g., at a pivot joint 46). Furthermore, the shank 38 may include a ground-engaging portion 48 extending from the base portion 44 along a curved or arcuate profile. The ground-engaging portion 48 may include a tip 50 that is configured to penetrate into or otherwise engage the soil as the agricultural implement 10 is being pulled through the field. However, in alternative embodiments, the shank 38 may be configured in any other suitable manner.

In several embodiments, an actuator 52 may be coupled between the frame 28 and the shank 38. As such, the actuator 52 may be configured to bias the shank 38 to a predetermined tool position (e.g., a home or base position) relative to the frame 28. In general, the predetermined tool position may correspond to a tool position in which the shank 38 penetrates the soil or ground to a desired depth. In several embodiments, the predetermined ground engaging tool position may be set by a mechanical stop 54. In operation, the actuator 52 may permit relative movement between the shank 38 and the frame 28. For example, the actuator 52 may be configured to bias the shank 38 to pivot relative to the frame 28 in a first pivot direction (e.g., as indicated by arrow 56 in FIG. 2) until an end 58 of the base portion 44 of the shank 38 contacts the stop 54. The actuator 52 may also allow the shank 38 to pivot away from the predetermined tool position (e.g., to a shallower depth of penetration), such as in a second pivot direction (e.g., as indicated by arrow 60 in FIG. 2) opposite the first pivot direction 56, when encountering rocks or other impediments in the field. Additionally, as will be described below, a computing system may be configured to control the operation of the actuator 52 to actively adjust a soil penetration depth (e.g., as indicated by arrow 62 in FIG. 2) of the shank 38 and/or the force applied to the shank 38.

It should be appreciated that the actuator 52 may be configured as any suitable type of actuator configured to bias the shank 38 relative to the frame 28 or otherwise apply a force to the shank 38. For example, in several embodiments, the actuator 52 may be configured as a suitable fluid-driven actuator, such as a suitable hydraulic or pneumatic cylinder. However, in alternative embodiments, the actuator 52 may be configured as any other suitable type of actuator, such as an electric linear actuator. Additionally, in a further embodiment, a spring (not shown) may be configured to bias the shank 38 relative to the frame 28 in lieu of the actuator 52.

In accordance with aspects of the present subject matter, the agricultural implement 10 may include one or more radar sensors 104 for use in detecting plugging of the agricultural implement 10. Specifically, in several embodiments, the radar sensor(s) 104 may be coupled to and/or supported on the agricultural implement 10 such that each radar sensor 104 has a field of view or detection zone (e.g., as indicated by dashed lines 106 in FIG. 2) directed toward a portion of the field through which one of the ground-engaging tools of the agricultural implement 10 is moving during the performance of an agricultural operation. As such, each radar sensor 104 may be configured to generate data indicative of a flow of the soil in the portion of the field present within its detection zone 106.

In general, in order to generate data indicative of a flow of the soil in the portion of the field through which the ground-engaging tool is moving, the radar sensor(s) 104 may be configured to emit output signals (e.g., radio wave and/or microwave signals) directed toward a portion of a field surface 64 within the corresponding detection zone 106. For instance, in several embodiments, the radar sensor(s) 104 may correspond to a multiple-input-multiple-output (MIMO) radar sensor(s). In such embodiments, each radar sensor 104 includes a plurality of transmitting antennas and/or a plurality of receiving antennas. Each transmitting antenna may, in turn, be configured to emit a unique output signal directed at the field surface 64 within its detection zone 106. A portion of each emitted output signal may be reflected by the field surface 64 as a corresponding echo signal. Each receiving antenna may be configured to receive portions of each reflected echo signal. As such, the receiving antennas may receive more echo signals than the transmitting antenna emit, thereby effectively enlarging the aperture(s) of the radar sensor(s) 104. Based on the time of flight, intensity, frequency, and/or phase of each received echo signal, the specific location (e.g., three-dimensional coordinates) of the field surface 64 relative to the corresponding radar sensor 104 may be calculated. Such calculations may generate a point cloud indicative of the flow in the portion of the field through which the corresponding ground-engaging tool is moving. However, in alternative embodiments, the radar sensor(s) 104 may correspond to any other suitable radar device(s), such as polarimetric radar device(s).

It should be appreciated that the radar sensor(s) 104 may be able to generate high-quality data indicative of the flow of the soil in the portion(s) of the field through which the ground-engaging tool(s) are moving in a variety of field conditions. For example, the emitted output signals and reflected echo signals may be able to penetrate dust clouds and other airborne debris typically generated during agricultural operations. Furthermore, the radar sensor(s) 104 may not be reliant on ambient light to detect the flow of the soil in the portion(s) of the field through which the ground-engaging tool(s) are moving.

As shown in FIG. 2, in several embodiments, a radar sensor 104 may be provided in operative association with each of the shanks 38. In such embodiments, the radar sensors 104 may be coupled to and/or supported on one of the frame members 32 such that the detection zone 106 of each radar sensor 104 is directed toward a portion of the field through which one of the shanks 38 is moving during the performance of a tillage operation. As such, each radar sensor 104 may be configured to generate data indicative of the flow of the soil through which the shank 38 is moving within its detection zone 106. In one embodiment, as shown in FIG. 2, the radar sensors 104 may be positioned aft of the shanks 38 relative to the direction of travel 14 of the agricultural implement 10. In such an embodiment, the radar sensors 38 may have forward-facing views of the flow of the soil through which the shanks 38 are moving. However, in alternative embodiments, the radar sensors 104 may be positioned forward of the shanks 38 relative to the direction of travel 14 such that the radar sensors 104 have rear-facing views of the flow of the soil through which the shanks 38 are moving. Moreover, in further embodiments, the radar sensors 104 may be aligned with the shanks 38 relative to the direction of travel 14 (i.e., each radar sensor 104 is next to the corresponding shank 38) such that the radar sensors 104 have side-facing views of the flow of the soil through which the shanks 38 are moving. Furthermore, although FIG. 2 shows a single radar sensor 104 provided in operative association with the illustrated shank 38, it should be appreciated that a plurality of radar sensors 104 may be provided in operative association with each shank 38.

Additionally, it should be appreciated that, in alternative embodiments, the radar sensor(s) 104 may be configured to generate data indicative of the flow of the soil in the portion(s) of the field through which any ground-engaging tool(s) of the agricultural implement 10 are moving. For example, the radar sensor(s) 104 may be configured to generate data indicative of the flow of the soil in the portion(s) of the field through which one or more of the disc blades 36 and/or the leveling blades 40 are moving. Moreover, in embodiments in which the agricultural implement 10 is configured as a seed-planting implement (e.g., a seeder, a planter, a side-dresser, and/or the like), the radar sensor(s) 104 may be configured to generate data indicative of the flow of the soil in the portion(s) of the field through which one or more of the disc openers, the gauge wheels, the closing discs/wheels, the residue removal devices, and/or the like are moving.

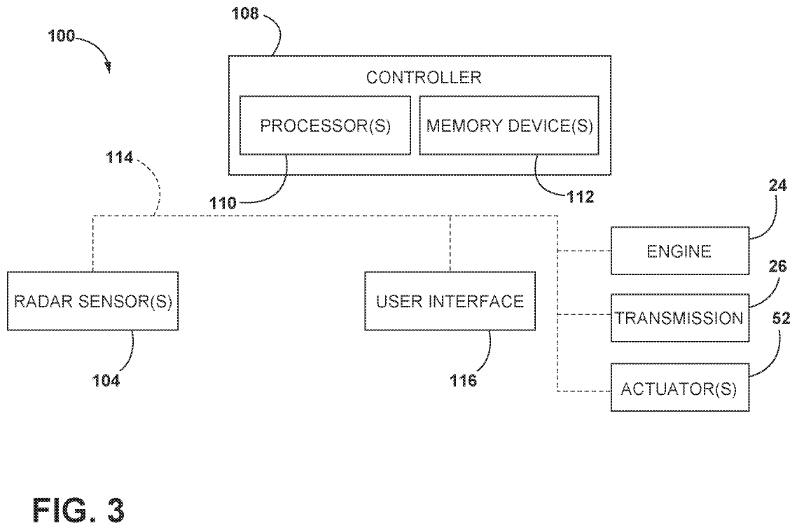

Referring now to FIG. 3, a schematic view of one embodiment of a system 100 for detecting plugging of an agricultural implement is illustrated in accordance with aspects of the present subject matter. In general, the system 100 will be described herein with reference to the agricultural implement 10 and the agricultural vehicle 12 described above with reference to FIGS. 1 and 2. However, it should be appreciated by those of ordinary skill in the art that the disclosed system 100 may generally be utilized with implements having any other suitable implement configuration and/or vehicles having any other suitable vehicle configuration.

As shown in FIG. 3, the system 100 may include a computing system 108 positioned on and/or within or otherwise associated with the agricultural implement 10 or the agricultural vehicle 12. The computing system 108 is communicatively coupled to one or more components of the agricultural implement 10, the agricultural vehicle 12, and/or the system 100 to allow the operation of such components to be electronically or automatically controlled by the computing system 108. For instance, the computing system 108 may be communicatively coupled to the radar sensor(s) 104 via a communicative link 114. As such, the computing system 108 may be configured to receive data from the radar sensor(s) 104 that is indicative of the flow of the soil in a portion of the field through which the ground-engaging tool is moving. Furthermore, the computing system 108 may be communicatively coupled the engine 24, the transmission 26, and/or the actuator(s) 52 via the communicative link 114. In this respect, the computing system 108 may be configured to control the operation of the engine 24, the transmission 26, and/or the actuator(s) 52 to adjust the ground speed at which the agricultural implement 10 travels across the field and/or adjust the soil penetration depth of the ground-engaging tool(s). In addition, the computing system 108 may be communicatively coupled to any other suitable components of the agricultural implement 10, the agricultural vehicle 12, and/or the system 100.

In general, the computing system 108 may comprise any suitable processor-based device known in the art, such as a given controller or computing device or any suitable combination of controllers or computing devices. Thus, in several embodiments, the computing system 108 may include one or more processor(s) 110 and associated memory device(s) 112 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 112 of the computing system 108 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 112 may generally be configured to store suitable computer-readable instructions that, when implemented by the processor(s) 110, configure the computing system 108 to perform various computer-implemented functions, such as one or more aspects of the methods and algorithms that will be described herein. In addition, the computing system 108 may also include various other suitable components, such as a communications circuit or module, one or more input/output channels, a data/control bus and/or the like.

It should be appreciated that the computing system 108 may correspond to an existing computing system(s) of the agricultural implement 10 and/or the agricultural vehicle 12, itself, or the computing system 108 may correspond to a separate processing device. For instance, in one embodiment, the computing system 108 may form all or part of a separate plug-in module that may be installed in association with the agricultural implement 10 and/or the agricultural vehicle 12 to allow for the disclosed systems to be implemented without requiring additional software to be uploaded onto existing control devices of the agricultural implement 10 and/or the agricultural vehicle 12. It should also be appreciated that the functions of the computing system 108 may be performed by a single processor-based device or may be distributed across any number of processor-based devices, in which instance such devices may be considered to form part of the computing system 108. For instance, the functions of the computing system 108 may be distributed across multiple application-specific controllers or computing devices, such as a navigation controller, an engine computing controller, a transmission controller, an implement controller and/or the like.

Furthermore, in one embodiment, the system 100 may also include a user interface 116. More specifically, the user interface 116 may be configured to provide feedback (e.g., feedback or input associated with the flow of the soil in the portion(s) of the field through which the ground-engaging tool(s) of the agricultural implement 10 are moving) to the operator of the agricultural implement/vehicle 10/12. As such, the user interface 116 may include one or more feedback devices (not shown), such as display screens, speakers, warning lights, and/or the like, which are configured to provide feedback from the computing system 108 to the operator. The user interface 116 may, in turn, be communicatively coupled to the computing system 108 via the communicative link 114 to permit the feedback to be transmitted from the computing system 108 to the user interface 116. In addition, some embodiments of the user interface 116 may include one or more input devices (not shown), such as touchscreens, keypads, touchpads, knobs, buttons, sliders, switches, mice, microphones, and/or the like, which are configured to receive user inputs from the operator. In one embodiment, the user interface 116 may be mounted or otherwise positioned within the cab 22 of the agricultural vehicle 12. However, in alternative embodiments, the user interface 116 may mounted at any other suitable location.

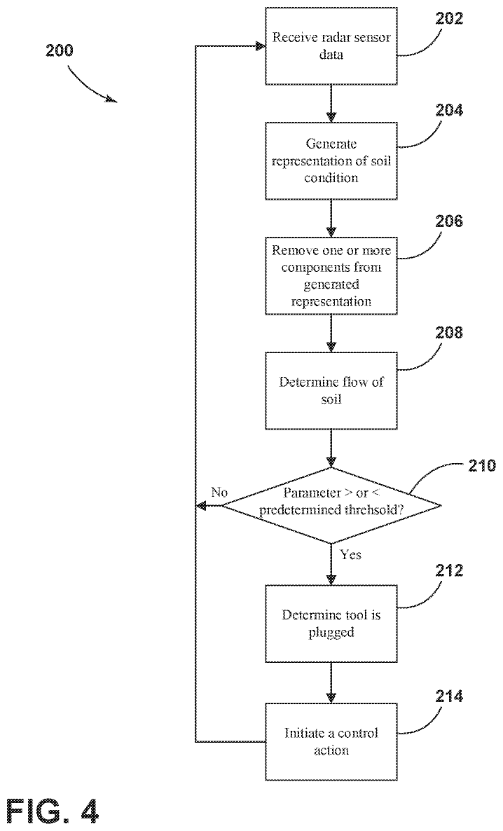

Referring now to FIG. 4, a flow diagram of one embodiment of control logic 200 that may be executed by the computing system 108 (or any other suitable computing system) for detecting plugging of an agricultural implement is illustrated in accordance with aspects of the present subject matter. Specifically, the control logic 200 shown in FIG. 4 is representative of steps of one embodiment of an algorithm that can be executed to detect plugging of an agricultural implement 10. Thus, in several embodiments, the control logic 200 may be advantageously utilized in association with a system installed on or forming part of an agricultural implement 10 to allow for real-time plugging detection of an agricultural implement 10 without requiring substantial computing resources and/or processing time. However, in other embodiments, the control logic 200 may be used in association with any other suitable system, application, and/or the like for detecting plugging of an agricultural implement 10. In general, the control logic 200 will be described herein with reference to the agricultural implement 10, the agricultural vehicle 12, and the system 100 described above with reference to FIGS. 1-3. However, in other embodiments, the control logic 200 may be used in association with any implement having any suitable implement configuration, any vehicle having any suitable vehicle configuration, any system having any suitable system configuration, and/or the like for detecting plugging of an agricultural implement.

As shown in FIG. 4, at (202), the control logic 200 includes receiving data from the radar sensor indicative of the flow of the soil in the portion of the field through which the ground-engaging tool is moving. As described above, the agricultural implement 10 may include one or more radar sensors 104, with each radar sensor 104 configured to generate data indicative of the flow of the soil in a portion of a field through which a ground-engaging tool (e.g., one of the disc blades 36, the shanks 38, and/or the leveling blades 40) of the agricultural implement 10 that is present within its detection zone 106 is moving. In this respect, as the agricultural implement 10 is moved across the field, the computing system 108 is configured to receive the data from the radar sensor(s) 104 via the communicative link 114.

Additionally, as shown in FIG. 4, at (204), the control logic 200 includes generating a representation of a flow of the soil in the portion of the field through which the ground-engaging tool is moving based on the received data from the radar sensor. As such, the computing system 108 may include a suitable algorithm(s) stored within its memory 112 that, when executed by the processor 110, generates the representation(s) of the flow the soil in the portion of the field through which the ground-engaging tool is moving based on the received data from the radar sensor(s) 104. The computing system 108 is configured to generate a representation that includes the field surface 64, the ground-engaging tool(s), the wheel(s) 66, and/or other components/features of the agricultural implement 10 within the detection zone 106 of the radar sensor(s) 104 when generating a representation of the flow of the soil in the portion of the field through which the ground-engaging tool is moving based on the received data from the radar sensor 104.

Furthermore, as shown in FIG. 4, at (206), the control logic 200 includes removing one or more components of the agricultural implement from the generated representation such that a modified representation of the flow of the soil in the portion of the field through which the ground-engaging tool is moving is created. As mentioned previously, the computing system 108 is configured to generate a representation that includes the field surface 64, the ground-engaging tool(s), the wheel(s) 66, and/or other components/features of the agricultural implement 10 within the detection zone 106 of the radar sensor(s) 104 when generating a representation of the flow of the soil in the portion of the field through which the ground-engaging tool is moving based on the received data from the radar sensor 104. As such, it may be difficult for the computing system 108 to distinguish between the field surface 64 and the components of the agricultural implement 10 when the generated representation includes data from the components of the agricultural implement 10 in addition to data from the field surface 64, and thus difficult for the computing system 108 to determine when the agricultural implement 10 is plugged. Therefore, the computing system 108 is configured to remove one or more components, such as the ground-engaging tool(s) (e.g., shanks 38), wheel(s) 66, and/or other components/features of the agricultural implement 10 within the detection zone 106 of the radar sensor(s) 104 from the generated representation. As such, a modified representation of the flow of the soil in the portion of the field through which the ground-engaging tool(s) is moving is created. In this respect, the amount of computing resources needed to determine when the ground-engaging tool is plugged is reduced.

Moreover, it should be appreciated that the generated representation(s) and modified representation(s), which will be discussed below, of the flow of the soil in the portion of the field in which the ground-engaging tool(s) are moving may correspond to any suitable data structure(s) that correlates the received radar data to the flow of the soil in the portion of the field in which the ground-engaging tool(s) are moving. For example, in several embodiments, the generated representation(s) and modified representation(s) may correspond to a plurality of three-dimensional images, with each image having a three-dimensional arrangement of captured data points. More specifically, the radar sensor(s) 104 may be configured to capture a plurality of data points, with each data point being indicative of the location of the field surface within the detection zone 106 of the corresponding sensor 104. In such embodiments, the computing system 108 may be configured to position each captured data point within a three-dimensional space corresponding to the detection zone(s) of the radar sensor(s) 104 to generate the three-dimensional image(s). As such, groups of data points within the generated image(s) and the modified image(s) may illustrate the locations and/or profiles of soil units (e.g., soil particles, soil clods, soil aggregations, and/or the like) currently present within the detection zone(s) 106 of the radar sensor(s) 104. However, in alternative embodiments, the initial three-dimensional representation of the field may correspond to any other suitable type of data structure, such as a data table.

Moreover, as shown in FIG. 4, at (208), the control logic 200 includes determining a flow of the soil in the portion of the field through which the ground-engaging tool is moving based on the generated modified representation. For example, the computing system 108 may be configured to determine a speed of the soil relative to a ground speed of the agricultural implement 10 within the detection zone(s) 106 of the radar sensor(s) 104. The speed of the soil relative to the ground speed of the agricultural implement 10 may be indicative of the soil flow. For instance, soil moving past the ground-engaging tool(s) of the agricultural implement 10 may be indicative of an unplugged soil condition while soil moving with the ground-engaging tool(s) may be indicative of a plugged soil condition.

Additionally, as shown in FIG. 4, at (210), the control logic 200 includes comparing the determined flow of the soil to a predetermined threshold flow of the soil. As such, the computing system 108 may be configured to compare the determined flow of the soil within the detection zone(s) 106 of the radar sensor(s) 104 to a predetermined threshold flow of the soil associated with plugging of the tool(s). Thereafter, when the determined flow of the soil falls outside of the predetermined threshold flow, the control logic 200 proceeds to (212), in which the computing system 108 is configured to determine that the ground-engaging tool(s) is plugged. Otherwise, the control logic 200 returns to (202).

In several embodiments, the determined flow of the soil corresponds to a determined speed of the soil relative to a ground speed of the agricultural implement 10. As such, the computing system 108 may be configured to compare the determined speed of the soil relative to the ground speed of the agricultural implement 10 within the detection zone(s) 106 of the radar sensor(s) 104 to a predetermined soil speed threshold. The predetermined soil speed threshold may correspond to a selected maximum soil speed, which may be selected as a maximum soil speed indicative of a plugged soil condition. Thereafter, when the determined speed of the soil falls below the predetermined soil speed threshold, the control logic 200 proceeds to (212), in which the computing system 108 is configured to determine that the ground-engaging tool(s) is plugged. Otherwise, the control logic 200 returns to (202).

Furthermore, as shown in FIG. 4, at (212), the control logic 200 includes determining that the ground-engaging tool is plugged when the determined flow falls outside of a predetermined threshold flow of the soil. For example, when a ground-engaging tool, such as one of the shanks 38, is plugged, the soil build-up on the shank 38 may pivot the shank 38 away from the soil such that the tip 50 of the shank 38 is prevented from penetrating the soil at a desired depth, thereby impacting the performance of the agricultural operation being performed by the shank 38. In general, a ground-engaging tool may be plugged when enough soil and/or residue has accumulated thereon such that the performance of the tool has been degraded or otherwise impacted.

Moreover, as shown in FIG. 4, at (214), the control logic 200 includes initiating a control action when determined that the ground-engaging tool is plugged. In general, such a control action may be associated with or otherwise intended to de-plug or otherwise remove soil already accumulated on the tool(s). Specifically, in several embodiments, the computing system 108 may be configured to automatically adjust one or more operating parameters of the agricultural implement 10 and/or the agricultural vehicle 12 when it is determined that one or more ground-engaging tools of the agricultural implement 10 are plugged. Specifically, in one embodiment, the computing system 108 may be configured to initiate adjustment of the force applied to and/or the soil penetration depth(s) of one or more ground-engaging tools (e.g., the disc blades 36, the shanks 38, and/or the leveling blades 40) of the agricultural implement 10. For example, the computing system 108 may be configured transmit instructions to the actuator(s) 52 (e.g., via the communicative link 114) instructing the actuator(s) 52 to adjust the force applied to and/or the soil penetration depth(s) of associated ground engaging tool(s). Once the control action(s) has been initiated, the control logic 200 returns to (202).

Additionally, in one embodiment, the computing system 108 may be configured to provide a notification to an operator of the agricultural implement 10 when the ground-engaging tool(s) is plugged. Specifically, the computing system 108 may be configured to transmit instructions to the user interface 116 (e.g., the communicative link 114) instructing the user interface 116 to provide a notification to the operator of the agricultural implement/vehicle 10/12 (e.g., by causing a visual or audible notification or indicator to be presented to the operator) indicating the ground-engaging tool(s) is plugged. Thereafter, the operator may then choose to adjust one or more operating parameters of the agricultural implement 10 and/or the agricultural vehicle 12 based on such notifications.

Furthermore, in one embodiment, the computing system 108 may be configured to automatically adjust the ground speed at which the agricultural implement/vehicle 10/12 is traveling across the field when it is determined one or more ground-engaging tools of the agricultural implement 10 are plugged. Specifically, the computing system 108 may be configured to transmit instructions to the engine 24 and/or the transmission 26 (e.g., via the communicative link 114) instructing the engine 24 and/or the transmission 26 to adjust their operation. For example, the computing system 108 may instruct the engine 24 to vary its power output and/or the transmission 26 to upshift or downshift to increase or decrease the ground speed of the agricultural implement/vehicle 10/12 in a manner that reduces or minimizes further accumulation of soil on the ground-engaging tool(s). However, in alternative embodiments, the computing system 108 may be configured to transmit instructions to any other suitable components (e.g., braking actuators) of the agricultural vehicle 12 and/or the agricultural implement 10 such that the ground speed of the agricultural implement/vehicle 10/12 is adjusted. Furthermore, it should be appreciated that any other suitable parameter(s) the agricultural implement 10 and/or the agricultural vehicle 12 may be adjusted when it is determined one or more ground-engaging tools of the agricultural implement 10 are plugged.

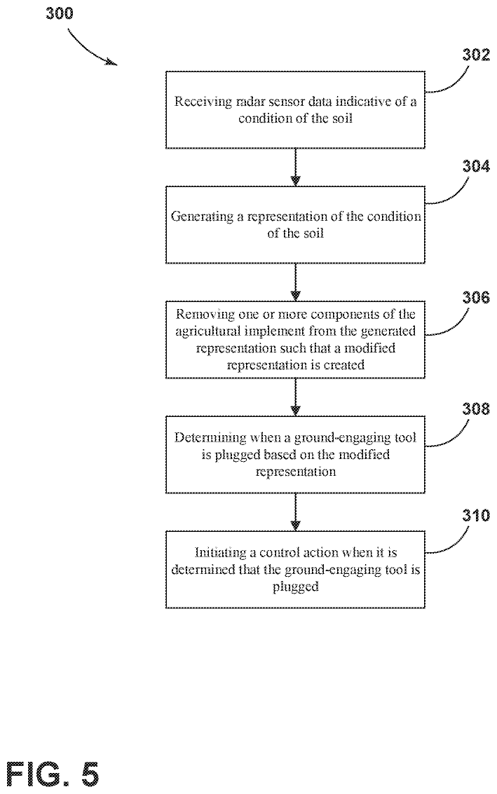

Referring now to FIG. 5, a flow diagram of one embodiment of a method 300 for detecting plugging of an agricultural implement is illustrated in accordance with aspects of the present subject matter. In general, the method 300 will be described herein with reference to the agricultural implement 10, the agricultural vehicle 12, the system 100, and the control logic 200 described above with reference to FIGS. 1-4. However, it should be appreciated by those of ordinary skill in the art that the disclosed method 300 may generally be implemented with any implement having any suitable implement configuration, any vehicle having any suitable vehicle configuration, any system having any suitable system configuration, and/or any suitable control logic 200. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 may include receiving, with a computing system, radar sensor data from a radar sensor configured to generate data indicative of a flow of the soil in a portion of the field through which the ground-engaging tool is moving. For instance, as described above, the computing system 108 may be configured to receive radar data from the radar sensor(s) 104 indicative of a flow of the soil in a portion of the field through which the ground-engaging tool(s) (e.g., one of the discs 36, the shanks 38, or the leveling discs 40) of the agricultural implement 10 is moving as the agricultural implement 10 travels across a field.

Additionally, at (304), the method 300 may include generating, with the computing system, a representation of the flow of the soil in the portion of the field through which the ground-engaging tool is moving based on the received data from the radar sensor. For instance, as described above, the computing system 108 may be configured to generate a representation of the flow of the soil in the portion of the field through which the ground-engaging tool of the agricultural implement 10 is moving based on the received data from the radar sensor.

Moreover, as shown in FIG. 5, at (306), the method 300 may include removing, with the computing system, one or more components of the agricultural implement from the generated representation such that a modified representation of the flow of the soil in the portion of the field through which the ground-engaging tool is moving is created. For instance, as described above, the computing system 108 may be configured to remove one or more components of the agricultural implement 10, such as the ground-engaging tool(s) (e.g., shank(s) 38) or the wheel 66, from the generated representation such that a modified representation of the flow of the soil in the portion of the field through which the ground-engaging tool is moving is created.

Furthermore, at (308), the method may include determining, with the computing system, when the ground-engaging tool is plugged based on the modified representation. For instance, as described above, the computing system 108 may be configured to determine when the ground-engaging tool of the agricultural implement 10 is plugged based on the modified representation.

Additionally, at (310), the method may include initiating, with the computing system, a control action when determined that the ground-engaging tool is plugged. For instance, as described above, the computing system 108 may be configured to initiate a control action when determined that the ground-engaging tool of the agricultural implement 10 is plugged.

It is to be understood that the steps of the control logic 200 and the method 300 are performed by the computing system 108 upon loading and executing software code or instructions which are tangibly stored on one or more tangible computer readable media, such as one or more magnetic media (e.g., a computer hard drive(s)), one or more optical media (e.g., an optical disc(s)), solid-state memory (e.g., flash memory), and/or other storage media known in the art. Thus, any of the functionality performed by the computing system 108 described herein, such as the control logic 200 and the method 300, is implemented in software code or instructions which are tangibly stored on one or more tangible computer readable media. The computing system 108 loads the software code or instructions via a direct interface with the one or more computer readable media or via a wired and/or wireless network. Upon loading and executing such software code or instructions by the computing system 108, the computing system 108 may perform any of the functionality of the computing system 108 described herein, including any steps of the control logic 200 and the method 300 described herein.

The term “software code” or “code” used herein refers to any instructions or set of instructions that influence the operation of a computing system, such as one or more computers or one or more controllers. They may exist in a computer-executable form, such as machine code, which is the set of instructions and data directly executed by a computing system's central processing unit(s) or by a controller(s), a human-understandable form, such as source code, which may be compiled in order to be executed by a computing system's central processing unit(s) or by a controller(s), or an intermediate form, such as object code, which is produced by a compiler. As used herein, the term “software code” or “code” also includes any human-understandable computer instructions or set of instructions (e.g., a script), that may be executed on the fly with the aid of an interpreter executed by a computing system's central processing unit(s) or by a controller(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A system for detecting plugging of an agricultural implement, the system comprising:
a ground-engaging tool configured to be moved through soil of a field as the agricultural implement travels across the field;
a radar sensor configured to generate data indicative of a flow of the soil in a portion of the field through which the ground-engaging tool is moving; and
a computing system communicatively coupled to the radar sensor, the computing system configured to:
generate a representation of the flow of the soil in the portion of the field through which the ground-engaging tool is moving based on the received data from the radar sensor;
remove one or more components of the agricultural implement from the generated representation such that a modified representation of the flow of the soil in the portion of the field through which the ground-engaging tool is moving is created; and
determine when the ground-engaging tool is plugged based on the modified representation.

2. The system of claim 1, wherein the computing system is further configured to:
determine a flow of the soil in the portion of the field through which the ground-engaging tool is moving based on the modified representation;
compare the determined flow of the soil to a predetermined threshold flow of the soil; and
determine that the ground-engaging tool is plugged when the determined flow falls outside of the predetermined threshold flow of the soil.

3. The system of claim 2, wherein:
the flow of the soil corresponds to a speed of the soil relative to a ground speed of the agricultural implement; and
the predetermined threshold flow of the soil corresponds to a predetermined soil speed threshold.

4. The system of claim 1, wherein, when removing one or more components of the agricultural implement from the generated representation, the computing system is further configured to:
remove the ground-engaging tool of the agricultural implement from the generated representation.

5. The system of claim 1, wherein, when removing one or more components of the agricultural implement from the generated representation, the computing system is further configured to:
remove the wheel of the agricultural implement from the generated representation.

6. The system of claim 1, wherein the computing system is further configured to initiate a control action when determined that the ground-engaging tool is plugged.

7. The system of claim 6, wherein the control action comprises notifying an operator of the agricultural implement that the ground-engaging tool is plugged.

8. The system of claim 6, wherein the control action comprises adjusting a ground speed of the agricultural implement.

9. The system of claim 6, wherein the control action comprises adjusting a soil penetration depth of the ground-engaging tool.

10. A method for detecting plugging of an agricultural implement, the method comprising:
receiving, with a computing system, radar sensor data from a radar sensor configured to generate data indicative of a flow of the soil in a portion of the field through which the ground-engaging tool is moving;
generating, with the computing system, a representation of the flow of the soil in the portion of the field through which the ground-engaging tool is moving based on the received data from the radar sensor;
removing, with the computing system, one or more components of the agricultural implement from the generated representation such that a modified representation of the flow of the soil in the portion of the field through which the ground-engaging tool is moving is created;
determining, with the computing system, when the ground-engaging tool is plugged based on the modified representation; and
initiating, with the computing system, a control action when determined that the ground-engaging tool is plugged.

11. The method of claim 10, further comprising:
determining, with the computing system, a speed of the soil in the portion of the field though which the ground-engaging tool is moving relative to a ground speed of the agricultural implement based on the modified representation;
comparing, with the computing system, the determined speed of the soil to a predetermined soil speed threshold; and
determining, with the computing system, that the ground-engaging tool is plugged when the determined speed of the soil falls below the predetermined soil speed threshold.

12. The method of claim 10, wherein, when removing one or more components of the agricultural implement from the generated representation, the method further comprises:
removing, with the computing system, the ground-engaging tool of the agricultural implement from the generated representation.

13. The method of claim 10, wherein, when removing one or more components of the agricultural implement from the generated representation, the method further comprises:
removing, with the computing system, the wheel of the agricultural implement from the generated representation.

14. The method of claim 10, wherein initiating the control action comprises:
notifying, with the computing system, an operator of the agricultural implement that the ground-engaging tool is plugged.

15. The method of claim 10, wherein initiating the control action comprises:
adjusting, with the computing system, a ground speed of the agricultural implement.

16. The method of claim 10, wherein initiating the control action comprises:
adjusting, with the computing system, a soil penetration depth of the ground-engaging tool.

17. An agricultural implement, comprising:
a frame;
a wheel supporting the frame and configured to allow movement of the agricultural implement across a field;
a ground-engaging tool supported by the frame and configured to be moved through soil of the field as the agricultural implement travels across the field;
a radar sensor configured to generate data indicative of a flow of the soil in a portion of the field through which the ground-engaging tool is moving; and
a computing system communicatively coupled to the radar sensor, the computing system configured to:
generate a representation of the flow of the soil in the portion of the field through which the ground-engaging tool is moving based on the received data from the radar sensor;
remove at least one of the ground-engaging tool or the wheel of the agricultural implement from the generated representation such that a modified representation of the flow of the soil in the portion of the field through which the ground-engaging tool is moving is created; and
determine when the ground-engaging tool is plugged based on the modified representation.

18. The agricultural implement of claim 17, wherein the computing system is further configured to:
determine a flow of the soil in the portion of the field through which the ground-engaging tool is moving based on the modified representation;
compare the determined flow of the soil to a predetermined threshold flow of the soil; and
determine that the ground-engaging tool is plugged when the determined flow falls outside of the predetermined threshold flow of the soil.

19. The agricultural implement of claim 18, wherein:
the flow of the soil corresponds to a speed of the soil relative to a ground speed of the agricultural implement; and
the predetermined threshold flow of the soil corresponds to a predetermined soil speed threshold.

20. The agricultural implement of claim 17, wherein the computing system is further configured to initiate a control action when determined that the ground-engaging tool is plugged.
